(19) United States
(12) Patent Application Publication
(10) Pub. No.: US 2025/0231420 A1
(43) Pub. Date: Jul. 17, 2025

(54) EYEGLASS ASSEMBLY FOR THE MOUNTING OF EYEGLASSES FROM A CAP

(71) Applicant: Russell Gelfuso, Warwick, RI (US)

(72) Inventor: Russell Gelfuso, Warwick, RI (US)

(21) Appl. No.: 18/121,244

(22) Filed: Mar. 14, 2023

(51) Int. Cl. G02C 3/02

(52) U.S. Cl. CPC G02C 3/02; G02C 2200/20

(57) ABSTRACT

A combination of a cap that is worn by a user, a pair of eyeglasses and an eyeglass assembly for the mounting of the eyeglasses from the cap, wherein the cap includes an interior peripheral rim that defines an upper rim edge that the eyeglasses are supported from, and wherein said eyeglasses include a pair of eye pieces and associated pair of temples. The eyeglass assembly includes:
a. a clip that includes a pair of clip side flanges connected at a clip bridge piece so that the clip is formed substantially in an inverted U-shape for disposition over the upper rim edge;
b. a non-slip insert including a pair of side flanges connected by a bridge piece so that the non-slip insert is formed substantially in an inverted U-shape for disposition inside the inverted U-shaped clip;
c. both of said clip and non-slip insert having indentations forming respective bumps so that the bumps of the non-slip insert engage with opposite sides of the interior peripheral rim of the cap while the bumps of the clip engage with respective insert side flanges.

### FIELD OF THE INVENTION

The present invention relates in general to an eyeglass assembly for mounting eyeglasses to a cap. More particularly, the present invention relates to an eyeglass assembly that improves the mounting arrangement of the eyeglass assembly.

### BACKGROUND OF THE INVENTION

This invention relates to a pair of glasses adapted to be attached to caps worn by humans and more specifically for utilization when caps are worn backwards, that is, with the cap's brim or visor facing to the rear. Visored caps such as baseball caps and the like have realized increased acceptance and importance in today's culture, and the habit of wearing such caps in the rearward position, that is, with the visor portion placed to the rear, is popular. It is also popular to mount eyeglasses, safety glasses and sunglasses to such caps such that the glasses may be disposed in a storage position and then pivoted or otherwise disposed to a use position with respect to the wearer, i.e., combination visored cap with glasses mounted thereon.

Despite the popularity of wearing such visored caps in the rearward position, the construction of the glasses to be mounted thereon are almost entirely structured so as to be clipped, suspended or otherwise attached or function with respect to the cap's brim or visor. Thus mounted, the glasses so attached to the cap will, of course, be proximate to the rear of the person's head when the cap is disposed in the rearward position and thus rendering the functionality of such mounted glasses useless. Examples of such visor or brim-oriented glasses/cap mountings include those shown in the following U.S. patents: U.S. Pat. No. 857,838 issued Jun. 25, 1907; U.S. Pat. No. 4,179,753 issued Dec. 25, 1979; U.S. Pat. No. 5,052,054 issued Oct. 1, 1991; U.S. Pat. No. 5,615,413 issued Apr. 1, 1997; U.S. Pat. No. 5,933,862 issued Aug. 10, 1999; U.S. Pat. No. 6,739,718 issued May 24, 2004; and U.S. Pat. No. 6,757,914 issued Jul. 6, 2004.

While some attempts have been made to provide glasses which include some attachment mechanism to enable use while the hat or cap's brim faces to the back or towards either side, the need still exists for a pair of glasses adapted for attachment to a cap such that the wearer may utilize the glasses when the cap is worn in the rearward facing position in a simple, straightforward and intuitively functional manner.

Refer also to the inventor's own U.S. Pat. Nos. 7,216,972 and 7,325,920. The present invention is considered as an improvement over the products described in these two patents. The improvement relates to, inter alia, the firm engagement of the device for providing an improved support from the cap.

### SUMMARY OF THE INVENTION

In accordance with the present invention there is provided an eyeglass assembly for the mounting of eyeglasses from a cap, wherein the cap includes an interior peripheral rim that defines an upper rim edge that the eyeglasses are supported from, and wherein said eyeglasses include a pair of eye pieces and associated pair of temples, said eyeglass assembly comprised of:
a. a clip that includes a pair of clip side flanges connected at a clip bridge piece so that the clip is formed substantially in an inverted U-shape for disposition over the upper rim edge;
b. a non-slip insert including a pair of side flanges connected by a bridge piece so that the non-slip insert is formed substantially in an inverted U-shape for disposition inside the inverted U-shaped clip;
c. both of said clip and non-slip insert having indentations forming respective bumps so that the bumps of the non-slip insert engage with opposite sides of the interior peripheral rim of the cap while the bumps of the clip engage with respective insert side flanges.

In accordance with other aspects of the present invention including a pad that is secured to the clip; including a temple connector that connects the temple of the eyeglass to a base of the clip; wherein the temple connector comprises a temple support piece, and further including a post that extends from the clip to the temple support piece; wherein a free end of the post is threaded for engagement with a threaded hole of the temple support piece; wherein the temple support piece includes a pivot connection that allows the eyeglasses to pivot away from the eyes; wherein the post has a S-shaped contour; wherein one of the clip flanges is longer than the other and has a pad attached thereto; wherein the clip flanges have opposed side lips for engagement with the non-slip insert; and wherein the temple connector comprises a temple support piece, and further including a post that extends from the clip to the temple support piece, and wherein the temple support piece includes a pivot connection that allows the eyeglasses to pivot away from the eyes.

Also in accordance with the present invention there is provided a combination of a cap that is worn by a user, a pair of eyeglasses and an eyeglass assembly for the mounting of the eyeglasses from the cap, wherein the cap includes an interior peripheral rim that defines an upper rim edge that the eyeglasses are supported from, and wherein said eyeglasses include a pair of eye pieces and associated pair of temples, said eyeglass assembly comprised of:
a. a clip that includes a pair of clip side flanges connected at a clip bridge piece so that the clip is formed substantially in an inverted U-shape for disposition over the upper rim edge;
b. a non-slip insert including a pair of side flanges connected by a bridge piece so that the non-slip insert is formed substantially in an inverted U-shape for disposition inside the inverted U-shaped clip;
c. both of said clip and non-slip insert having indentations forming respective bumps so that the bumps of the non-slip insert engage with opposite sides of the interior peripheral rim of the cap while the bumps of the clip engage with respective insert side flanges.

In accordance with other aspects of the combination of the present invention; including a pad that is secured to the clip; including a temple connector that connects the temple of the eyeglass to a base of the clip; wherein the temple connector comprises a temple support piece, and further including a post that extends from the clip to the temple support piece; wherein a free end of the post is threaded for engagement with a threaded hole of the temple support piece; wherein the temple support piece includes a pivot connection that allows the eyeglasses to pivot away from the eyes; wherein the post has a S-shaped contour; wherein one of the clip flanges is longer than the other and has a pad attached thereto; wherein the clip flanges have opposed side lips for engagement with the non-slip insert; and wherein the temple connector comprises a temple support piece, and further including a post that extends from the clip to the temple support piece, and wherein the temple support piece includes a pivot connection that allows the eyeglasses to pivot away from the eyes.

### BRIEF DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1 is a perspective view illustrating the eyeglass assembly for the support of eyeglasses from the rim of a cap;

FIG. 2 is a perspective view of the pair of eyeglass assemblies for engagement with opposite portions of the rim of the cap;

FIG. 3 is a perspective view illustrating the support clip of the present invention partially cut away to also illustrate the non-slip insert;

FIG. 4 is a perspective exploded view showing the clip and the non-slip insert;

FIG. 5 is a partial perspective view of one side of the clip;

FIG. 6 is a partial perspective view of the opposite side of the clip;

FIG. 7 is a side view of the clip;

FIG. 8 is a front view of the clip;

FIG. 9 is a bottom view of the clip;

FIG. 10 is a side cross-sectional view taken along line 10-10 of FIG. 8 showing the clip without the non-slip insert;

FIG. 11 is a cross-sectional view taken along line 11-11 of FIG. 8;

FIG. 12 is a perspective view of the non-slip insert;

FIG. 13 is a side view of the non-slip insert;

FIG. 14 is a front view of the non-slip insert;

FIG. 15 is a cross-sectional view taken along line 15-15 of FIG. 14;

FIG. 16 is an enlarged view of the clip as attached to the cap;

FIG. 17 is a cross-sectional view showing the non-slip insert engaged with the cap rim;

FIG. 18 is a cross-sectional view showing the clip being placed over the non-slip insert with interlocking indentations/bumps;

FIG. 19 is a side view of the eyeglass assembly when in use;

FIG. 20 is a side view of the eyeglass assembly when tilted away from use;

FIG. 21 is a schematic front view illustrating another concept of the present invention;

FIG. 22 is a front view showing the respective temples with end tabs being inserted into slots in the frame; and

FIG. 23 is a top view showing the temples locked in place.

### DETAILED DESCRIPTION

Reference is now made to the drawings for an illustration of the eyeglass assembly of the present invention. This eyeglass assembly is for the mounting of a pair of eyeglasses 10 from a cap 14. The cap includes an interior peripheral rim 15 that defines an upper rim edge 17 that the eyeglasses are supported from. The eyeglasses include a frame 16 and a pair of eye pieces 18.

The eyeglass assembly is comprised of a clip 26 that includes a pair of clip side flanges 27 and a clip bridge piece 39 so that the clip is formed substantially in an inverted U-shape for disposition over the non-slip insert and in turn over the upper rim edge 17. Both the clip and the non-slip insert have indentations forming respective bumps so the bumps of the non-slip insert engage with opposite sides of the interior peripheral rim of the cap while the bumps of the clip engage with respective side flanges, and in particular the indentations thereof.

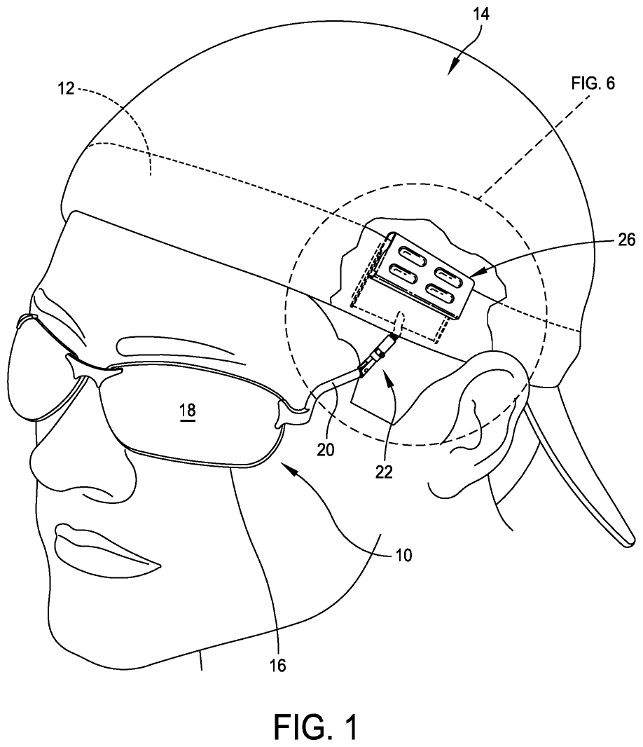

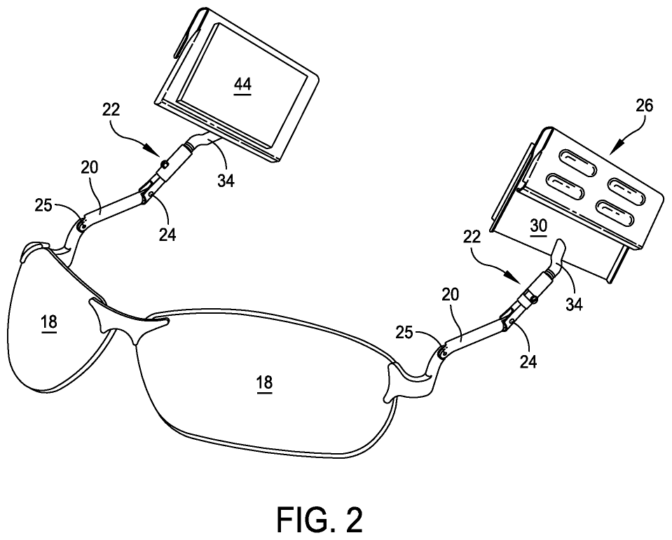

FIG. 1 is a perspective view illustrating the eyeglass assembly for the support of eyeglasses from the rim of a cap. FIG. 2 is a perspective view showing the eyeglass assembly which includes a temple connector 22 for connecting the temple 20 of the eyeglass to the clip 26. FIG. 2 also illustrates the cushioning pad 44 that provides enhanced comfort against the head of the user. Note in FIG. 2 the two pivots 24 and 25. Pivot 24 in particular allows the eye lenses or eye pieces to be adjusted to different angles when the cap is raised or lowered.

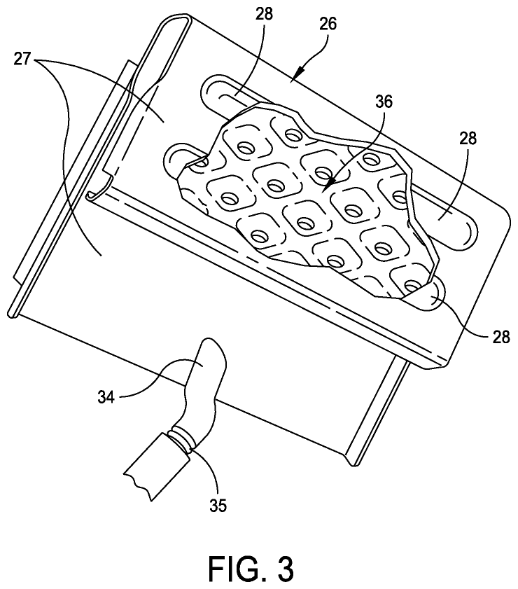

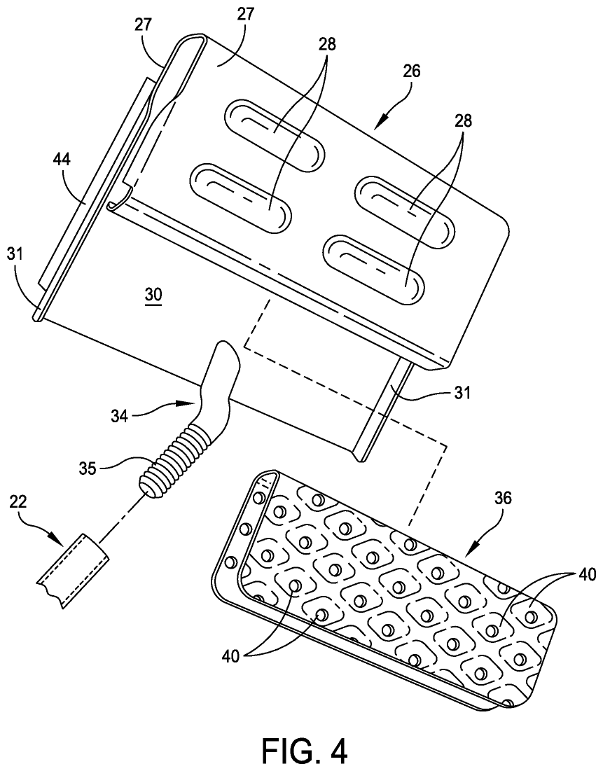

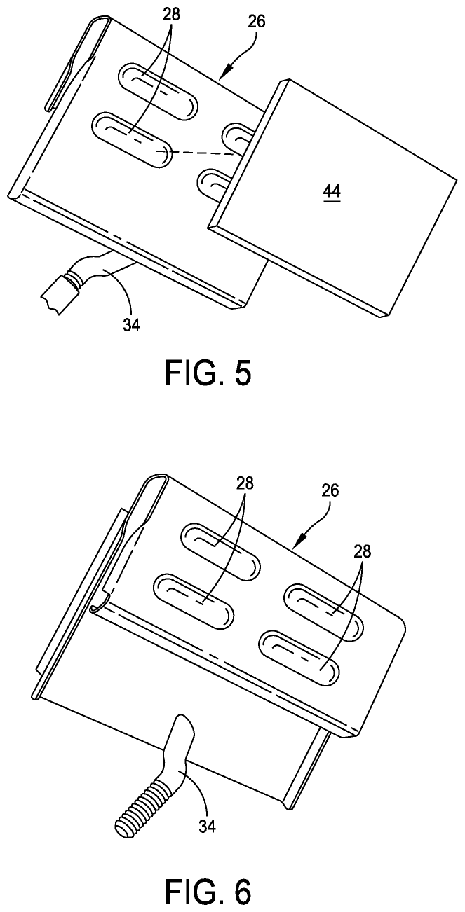

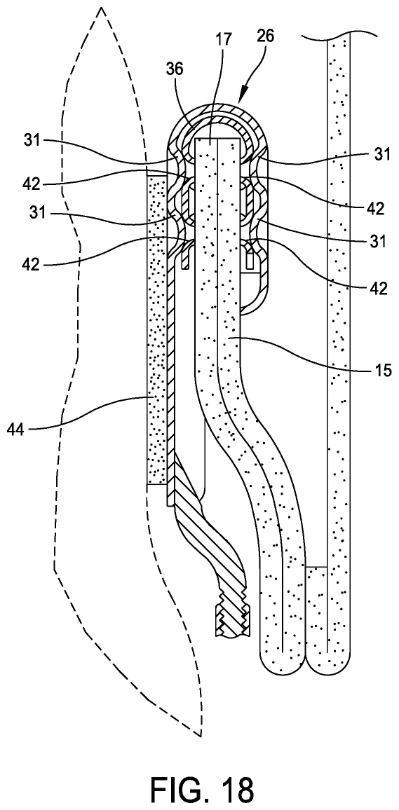

FIG. 3 is a perspective view illustrating the support clip of the present invention partially cut away so as to illustrate the non-slip insert at 36. FIG. 4 is a perspective view exploded away from the clip 26. In FIG. 4 also note side lips 33. These side lips 33 are helpful in guiding the clip over the non-slip insert. FIG. 5 is a perspective view showing the clip on one side where the pad 44 is secured. The pad 44 may be secured by an adhesive. In this regard also refer to the cross-sectional view of FIG. 18. FIG. 6 is a perspective view showing the opposite side of the clip with the associated clip indentations 28.

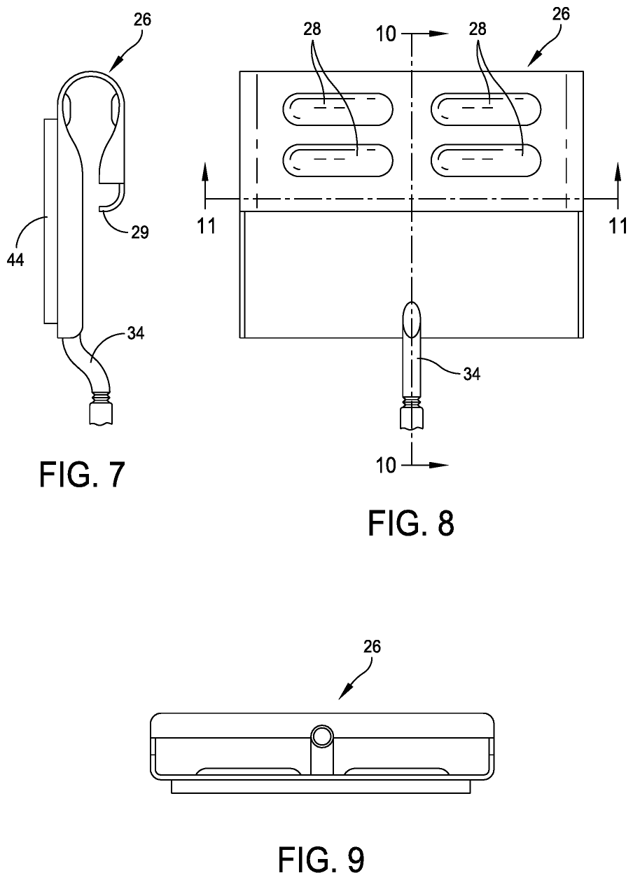

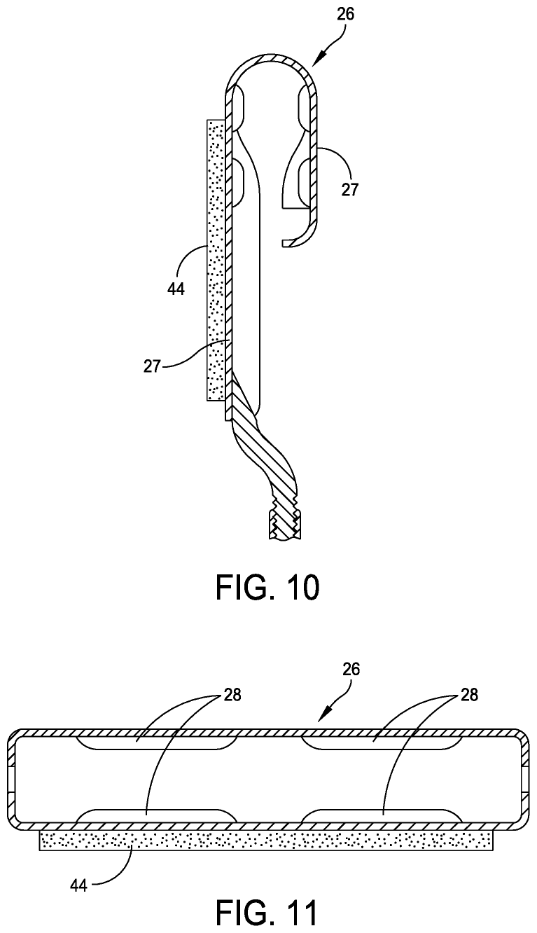

FIG. 7 is a side view of the clip 26. FIG. 8 is a front view of the clip 26. FIG. 9 is a bottom view of the clip 26. FIG. 10 is a side cross-sectional view taken along line 10-10 of FIG. 8 showing the clip without the non-slip insert. FIG. 11 is a cross-sectional view taken along line 11-11 of FIG. 8.

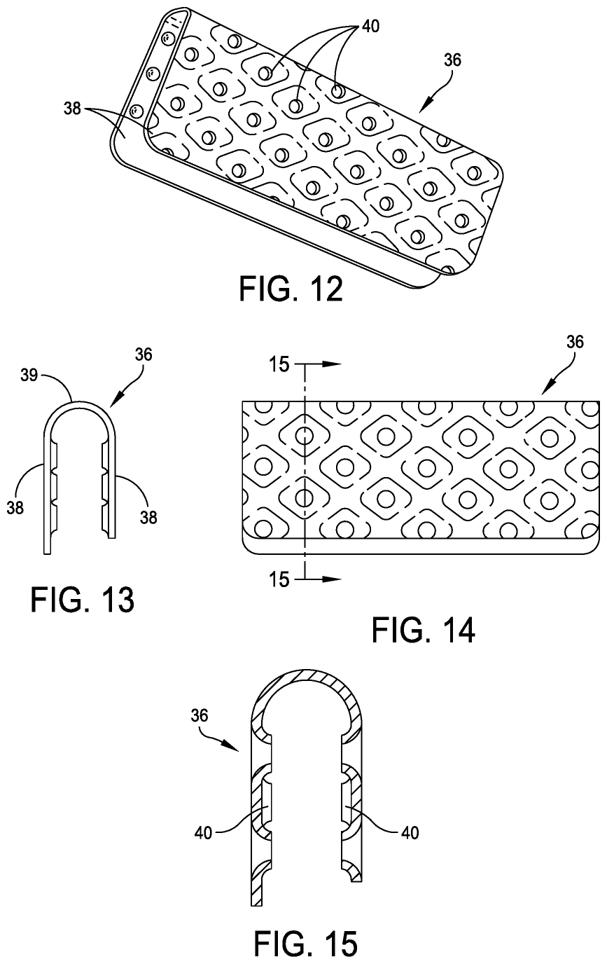

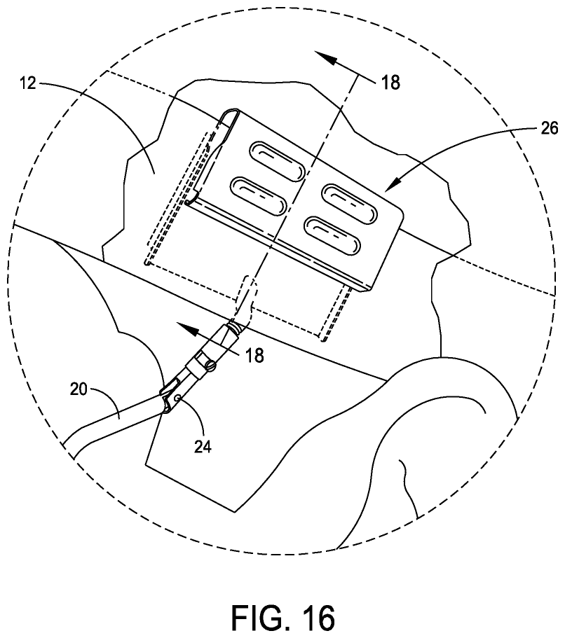

FIG. 12 is a perspective view of the non-slip insert alone. FIG. 12 illustrates the opposed side flanges 38 as well as a bridge at 39. FIG. 13 is a side view of the non-slip insert. FIG. 14 is a front view of the non-slip insert. FIG. 15 is a cross-sectional view taken along line 15-15 of FIG. 14.

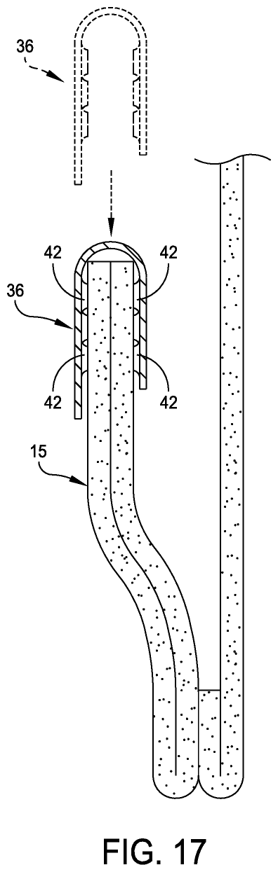

FIG. 16 is an enlarged view of the clip as engaged with the rim of the cap. FIG. 17 is a cross-sectional view showing the non-slip insert engaged with the cap rim. FIG. 18 is a cross-sectional view taken along line 18-18 of FIG. 16 illustrating the clip being placed over the non-slip insert.

One of the features of the present invention is the manner in which the indentations and bumps are formed both on the clip and on the insert. This is clearly illustrated in the cross-sectional view of FIG. 18 wherein the bump 31 of the clip is aligned with an insert indentation 40. The bump 42 of the insert thus rests against the rim 15. This arrangement enhances the gripping action of the clip and insert with the rim of the cap.

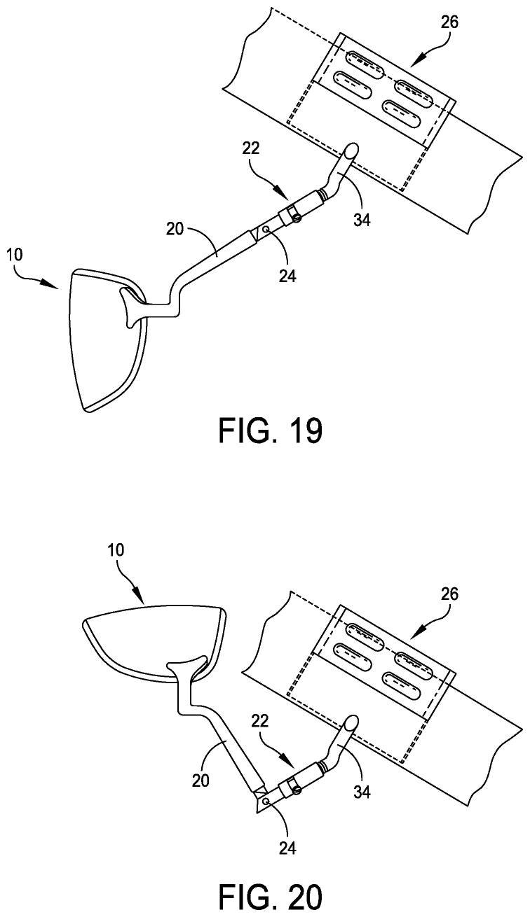

FIG. 19 is a side view of the eyeglass assembly when in use. In other words, in FIG. 19 the eyeglasses are disposed over the eye of the user. FIG. 20 is a side view of the eyeglass assembly once tilted upwardly at pivot 24 so that the eyeglasses are no longer engaged with the eye of the user but are moved upwardly out of the way.

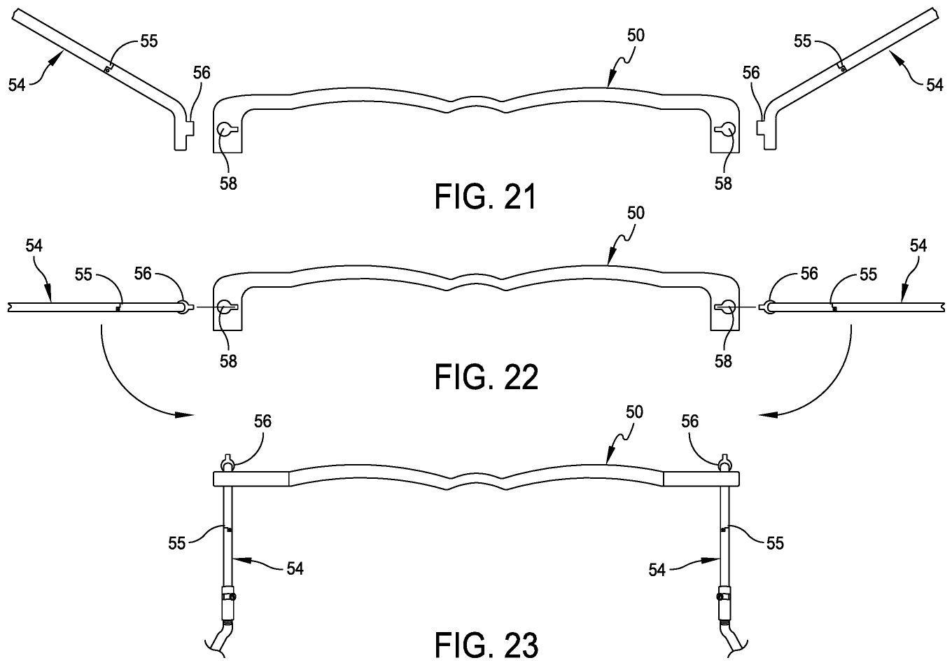

Reference is now made to FIGS. 21-23 for another important aspect of the present invention in which the temples 54 can be engaged and disengaged with the eyeglass frame 50. In this way, one can substitute different types or styles of frames with any particular set of temples. Thus, this embodiment allows a pair of temples to attach to multiple frames. These frames can be of many different types such as readers, safety glasses or sunglasses.

With further reference to FIGS. 21-23, the temples 54 have their ends 56 inserted into the slots 58 in the frame. The slots may be provided on the front of the frames. The temples may be inserted in line with the front of the frame. Each temple is pushed down passed the end tab swinging toward each other which locks the temples in place relative to the frame. In an alternate embodiment, one can provide a threaded screw in place of the tab. This threaded screw allows room for a nut to hold the temple in place. On each temple there may also be provided an additional hinge joint 55 such as illustrated in FIGS. 21-23.

Reference Numbers

| | |
|---|---|
| glasses | 10 |
| headband | 12 |
| cap | 14 |
| interior rim of the cap | 15 |
| frame of the glasses | 16 |
| upper edge of the rim | 17 |
| eyepiece | 18 |
| temples | 20 |
| temple connector | 22 |
| temple pivot | 24 |
| temple pivot | 25 |
| clip | 26 |
| clip flanges | 27 |
| clip indentations | 28 |
| clip turned end | 29 |
| clip base | 30 |
| clip bump | 31 |
| clip side lips | 33 |
| temple supportpiece | 34 |
| threaded end of temple support | 35 |
| non-slip insert | 36 |
| insert side flanges | 38 |
| insert bridge | 39 |
| insert indentations | 40 |
| insert bump | 42 |
| pad | 44 |
| eyeglass frame | 50 |
| respective temples | 54 |
| temple hinge | 55 |
| temple ends | 56 |
| frame slots | 58 |

Having now described a limited number of embodiments of the present invention, it should now be apparent to those skilled in the art that numerous other embodiments and modifications thereof are contemplated as falling within the scope of the present invention, as defined by the appended claims.

What is claimed is:

1. An eyeglass assembly for the mounting of eyeglasses from a cap, wherein the cap includes an interior peripheral rim that defines an upper rim edge that the eyeglasses are supported from, and wherein said eyeglasses include a pair of eye pieces and associated pair of temples, said eyeglass assembly comprised of:
a. a clip that includes a pair of clip side flanges connected at a clip bridge piece so that the clip is formed substantially in an inverted U-shape for disposition over the upper rim edge;
b. a non-slip insert including a pair of side flanges connected by a bridge piece so that the non-slip insert is formed substantially in an inverted U-shape for disposition inside the inverted U-shaped clip;
c. both of said clip and non-slip insert having indentations forming respective bumps so that the bumps of the non-slip insert engage with opposite sides of the interior peripheral rim of the cap while the bumps of the clip engage with respective insert side flanges.

2. The eyeglass assembly of claim 1 including a pad that is secured to the clip and wherein the frame has a slot for receiving a tab at the end of each temple to allow a pair of temples to attach to multiple different frames structures.

3. The eyeglass assembly of claim 1 further including a temple connector that connects the temple of the eyeglass to a base of the clip.

4. The eyeglass assembly of claim 3 wherein the temple connector comprises a temple support piece, and further including a post that extends from the clip to the temple support piece.

5. The eyeglass assembly of claim 4 wherein a free end of the post is threaded for engagement with a threaded hole of the temple support piece.

6. The eyeglass assembly of claim 5 wherein the temple support piece includes a pivot connection that allows the eyeglasses to pivot away from the eyes.

7. The eyeglass assembly of claim 6 wherein the post has a S-shaped contour, and wherein the bump of the clip is aligned with an insert indentation while the bump of the insert rests against the rim, thus enhances the gripping action of the clip and insert with the rim of the cap.

8. The eyeglass assembly of claim 1 wherein one of the clip flanges is longer than the other and has a pad attached thereto.

9. The eyeglass assembly of claim 8 wherein the clip flanges have opposed side lips for engagement with the non-slip insert.

10. The eyeglass assembly of claim 9 wherein the temple connector comprises a temple support piece, and further including a post that extends from the clip to the temple support piece, and wherein the temple support piece includes at least one pivot connection that allows the eyeglasses to pivot away from the eyes.

11. A combination of a cap that is worn by a user, a pair of eyeglasses and an eyeglass assembly for the mounting of the eyeglasses from the cap, wherein the cap includes an interior peripheral rim that defines an upper rim edge that the eyeglasses are supported from, and wherein said eyeglasses include a pair of eye pieces and associated pair of temples, said eyeglass assembly comprised of:
a. a clip that includes a pair of clip side flanges connected at a clip bridge piece so that the clip is formed substantially in an inverted U-shape for disposition over the upper rim edge;
b. a non-slip insert including a pair of side flanges connected by a bridge piece so that the non-slip insert is formed substantially in an inverted U-shape for disposition inside the inverted U-shaped clip;
c. both of said clip and non-slip insert having indentations forming respective bumps so that the bumps of the non-slip insert engage with opposite sides of the interior peripheral rim of the cap while the bumps of the clip engage with respective insert side flanges.

12. The combination of claim 11 including a pad that is secured to the clip.

13. The combination of claim 11 further including a temple connector that connects the temple of the eyeglass to a base of the clip.

14. The combination of claim 13 wherein the temple connector comprises a temple support piece, and further including a post that extends from the clip to the temple support piece.

15. The combination of claim 14 wherein a free end of the post is threaded for engagement with a threaded hole of the temple support piece.

16. The combination of claim 15 wherein the temple support piece includes a pivot connection that allows the eyeglasses to pivot away from the eyes.

17. The combination of claim 16 wherein the post has a S-shaped contour, and wherein the bump of the clip is aligned with an insert indentation while the bump of the insert rests against the rim, thus enhances the gripping action of the clip and insert with the rim of the cap.

18. The combination of claim 11 wherein one of the clip flanges is longer than the other and has a pad attached thereto.

19. The combination of claim 18 wherein the clip flanges have opposed side lips for engagement with the non-slip insert.

20. The combination of claim 19 wherein the temple connector comprises a temple support piece, and further including a post that extends from the clip to the temple support piece, and wherein the temple support piece includes at least one pivot connection that allows the eyeglasses to pivot away from the eyes.
